(19) United States
(12) Patent Application Publication
(10) Pub. No.: US 2014/0320419 A1
(43) Pub. Date: Oct. 30, 2014

(54) TOUCH INPUT DEVICE

(71) Applicant: DEXIN CORPORATION, New Taipei City (TW)

(72) Inventor: YUAN-JUNG CHANG, NEW TAIPEI CITY (TW)

(73) Assignee: DEXIN CORPORATION, New Taipei City (TW)

(21) Appl. No.: 13/870,005

(22) Filed: Apr. 25, 2013

(51) Int. Cl. G06F 3/041

(52) U.S. Cl. CPC G06F 3/041
USPC 345/173

(57) ABSTRACT

A touch input device for controlling an electronic device comprises a body, a display layer, a touch layer, a processing unit, and a pressing element. The body comprises a containing portion. The display layer disposed on the body is used for displaying at least one virtual key. The touch layer disposed on the display layer is used for sensing whether a virtual key has been touched by a user and generates a sensing signal. The processing unit disposed in the containing portion electrically connects the touch layer and the display layer. The pressing element is disposed below the touch layer and electrically connected with the processing unit. When user touches any virtual key with a press force larger than a predetermined force, the pressing element is instantly pressed. The processing unit is used for controlling operations of electronic device according to a sensing signal and a pressing signal.

### BACKGROUND OF THE INVENTION

1. Field of the Invention

The present invention relates to an input device; in particular, to a touch input device.

2. Description of Related Art

In the recent year, accompanied with the prosperous development of electronic technology, an input device (for example, a mouse) replaces our fingers to perform many clicking operations necessary for operating an electronic device. The control mode for controlling an electronic device is gradually evolved from a mechanical mode to an optical mode, and even to a touch mode today.

A conventional touch input device may generate a touch signal when a user touches an outer surface of the input device shell, and the touch signal is permitted to perform the control of the electronic device. However, the keying position of a conventional touch input device is limited by the shape and size of the input device, and the keying position has been fixed when a manufacturer manufactures an input device. Therefore, a user cannot exchange the keying position at will according to personal preference. In addition, the keying amount of a conventional touch input device will be limited due to the size of the input device. Therefore, inconvenience of a user is resulted. Furthermore, when a user wishes to exchange the keying functions of any input device, generally the software attached by the manufacturer is used to modify the keying functions, thus some inconveniences of a user are also resulted.

### SUMMARY OF THE INVENTION

The object of an embodiment of the present invention is to provide a touch input device of high freedom for current game market and text processing market, and virtual keys of different functions are set according to user's preferences. A monotonous input manner of a conventional touch input device and inconvenience of a touch input device can be improved, so that the touch input device can be used more flexibly and the requirements of different users can further satisfied.

An embodiment of the present invention provides a touch input device suitable for controlling an electronic device. The touch input device comprises a body, a display layer, a touch layer, a processing unit and a pressing element. The body has a containing portion. The display layer disposed on the body is used for displaying at least one virtual key. The touch layer disposed on the display layer is used for sensing whether a virtual key has been touched by a user and thus generates a sensing signal. The processing unit disposed in the containing portion electrically connects the touch layer and the display layer. The pressing element is disposed below the touch layer and electrically connected with the processing unit. When a user touches any virtual key with a press force larger than a predetermined force, the pressing element is instantly pressed and generates a pressing signal. The processing unit is used for controlling the operations of the electronic device according to a sensing signal generated by the touch layer and a pressing signal generated by the pressing element.

Summing up the above, an embodiment of the present invention provides a touch input device. When any virtual key is touched by a user with a press force larger than a predetermined force, the pressing element is instantly pressed to generate a pressing signal, so that the processing unit can control the operations of the electronic device by means of a sensing signal generated by the touch layer and a pressing signal generated by the pressing element. Hence, the problem of mechanical keying state deficient of being sensed by fingers for a conventional touch input device is solved, and monotonous input manner of a conventional touch input device and inconvenience of a touch input device are improved.

In order to further the understanding regarding the present invention, the following embodiments are provided along with illustrations to facilitate the disclosure of the present invention. However, the following embodiments are merely provided for reference and illustration, without any intention to be used for limiting the present invention.

### BRIEF DESCRIPTION OF THE DRAWINGS

FIG. 1A shows a schematic diagram of a touch input device according to an embodiment of the present invention;

FIG. 1B shows a sectional diagram of the touch input device according to FIG. 1A of the present invention;

FIG. 2 shows a decomposition diagram of a touch input device according to an embodiment of the present invention;

FIG. 3 shows a decomposition diagram of a touch input device according to another embodiment of the present invention;

FIG. 4 shows a schematic diagram of a touch input device according to another embodiment of the present invention;

### DETAILED DESCRIPTION OF THE PREFERRED EMBODIMENTS

The aforementioned illustrations and following detailed descriptions are exemplary for the purpose of further explaining the scope of the present invention. Other objects and advantages related to the present invention will be illustrated in the subsequent descriptions and appended drawings.

[Embodiment of a Touch Input Device]

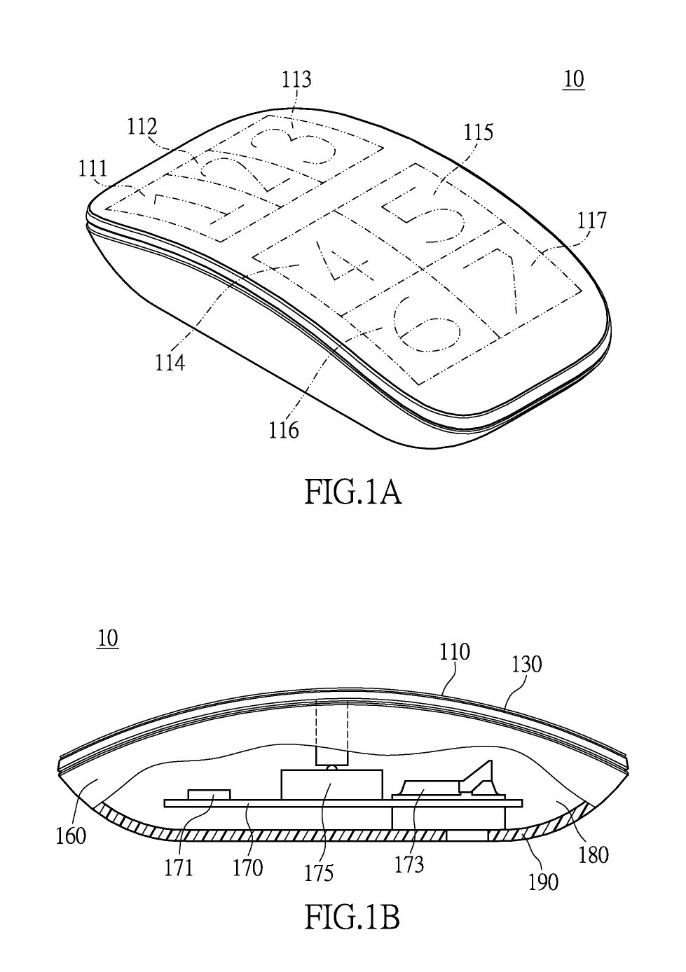

At first, please refer to FIG. 1A and FIG. 1B. FIG. 1A shows a stereoscopic schematic diagram of a touch input device according to an embodiment of the present invention; FIG. 1B shows a sectional diagram of the touch input device according to FIG. 1A of the present invention. As shown in FIGS. 1A and 1B, the touch input device 10 is suitable for controlling an electronic device and comprises a body 160, a touch layer 110, a display layer 130, a circuit board 170, a processing unit 171, an optical sensing element 173 and a pressing element 175. The body 160 has a containing portion 180 for accommodating the processing unit 171. In the present embodiment, the processing unit 171 and the pressing element 175 are all set on the circuit board 170. However, the setting modes of the processing unit 171 and the pressing element 175 are not limited in the present invention, so long as the processing unit 171 is set in the containing portion 180 and the pressing element 175 is set below the touch layer 110.

In the present embodiment, the display layer 130 is of an arc-curved surface shape and disposed on the body 160 to be electrically connected with the processing unit 171. The upper surface of the display layer 130 displays several virtual keying areas 111, 112, 113, 114, 115, 116, 117, while each of the virtual keying areas 111, 112, 113, 114, 115, 116, 117 may display numerical keys 1, 2, 3, 4, 5, 6, 7. For example, the virtual keying area 111 may display a numerical key 1, and the virtual keying area 112 may display a numerical key 2 and so on. In addition, the numerical keys 1, 2, 3, 4, 5, 6, 7 are functional keys too. For example, the numerical key 1 may represent a Ctrl+Alt key of a keyboard. Furthermore, the numerical keys and the functional keys may simultaneously exist on the virtual keying areas 111, 112, 113, 114, 115, 116, 117. For example, the numerical keys are 1, 2, 3, while the functional keys are 4, 5, 6, 7. Therefore, whether the virtual keying areas 111, 112, 113, 114, 115, 116, 117 are all used to display numerical keys or functional keys or to display numerical keys and functional keys together is not limited in the present embodiment.

The touch layer 110 is disposed on the display layer and electrically connected to the processing unit 171. In the present embodiment, the shape of the touch layer 110 shows in fact a conductor-film structure of an arc-curved surface shape. However, in practice the shape of the touch layer 110 can be designed according to application requirement of real products. For example, the shape of the touch input device 10 is rectangular, then the touch layer 110 is designed according to outline of the touch input device 10. In addition, whether the touch layer 110 is a capacitive touch layer or a resistive touch layer is not limited in the present embodiment. The one skilled in the art can design the touch layer 110 according to practical using condition.

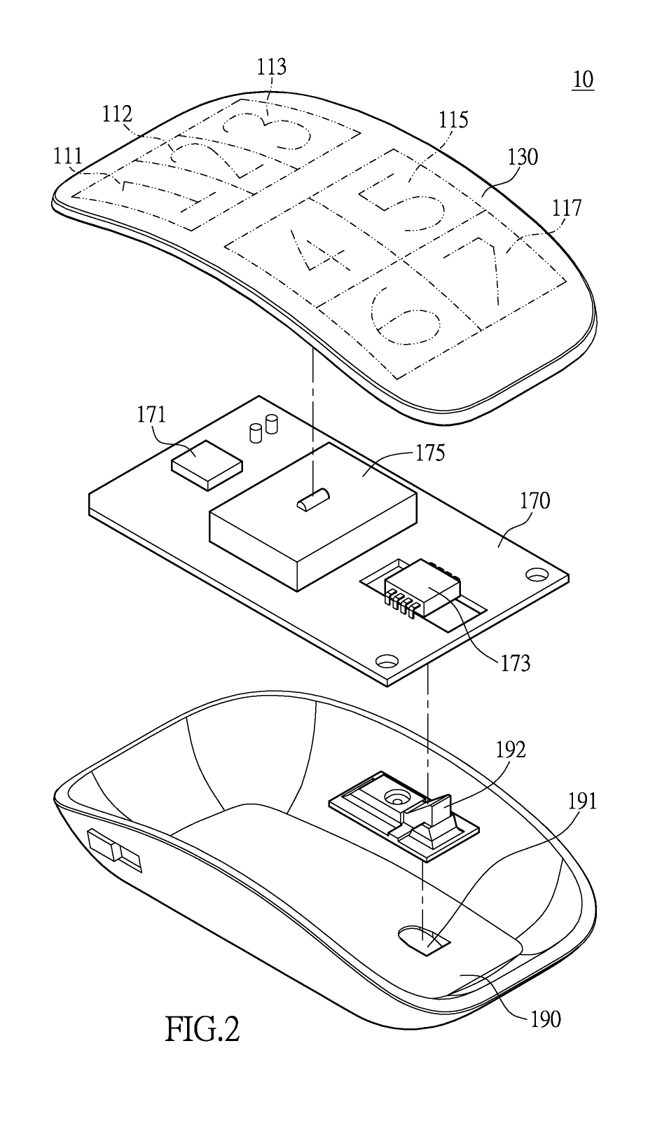

Please refer to FIG. 2 along with FIG. 1B. FIG. 2 shows a decomposition diagram of a touch input device according to an embodiment of the present invention. As shown in FIG. 2, the circuit board 170 is provided with a processing unit 171, an optical sensing element 173 and a pressing element 175. The pressing element 175 is electrically connected to the processing unit 171 and disposed correspondingly below the several virtual keying areas 111, 112, 113, 114, 115, 116, 117. The bottom shell 190 in the present embodiment is provided with a light guide element 192 and a through-port 191, and the light guide element 192 is located above the through-port 191. The circuit board 170 is provided with an optical sensing element 173 corresponding to the light guide element 192. The optical sensing element 173 and the light guide element 192 form a mobile sensing module for sensing a reflective light signal on a plane disposed for the touch input device 10.

When a user is in operation, the user may move the touch input device 10 at will, at this moment the optical sensing element 173 generates a light that passes through the light guide element 192 and the through-port 191 to a desk surface, while the light reflected from the desk surface is transmitted through the light guide element 192 to the optical sensing element 173. Then, through signal analysis and processing, the moving direction and distance of the touch input device 10 can be precisely calculated, so as to synchronously control the cursor position on a using interface of an electronic device. When a user touches any one of the virtual keying areas 111, 112, 113, 114, 115, 116, 117 but does not apply a press force larger than a predetermined force to any one of the virtual keying areas 111, 112, 113, 114, 115, 116, 117, the pressing element may not be actuated. On the other hand, when a user touches any one of the virtual keying areas 111, 112, 113, 114, 115, 116, 117 and applies a press force larger than a predetermined force to any one of the virtual keying areas 111, 112, 113, 114, 115, 116, 117, the pressing element will be instantly pressed to generate a pressing signal, at the same time the pressing element may generate a sound effect, so as to let the user determine whether any one of the virtual keying areas 111, 112, 113, 114, 115, 116, 117 is actually touched and actually pressed, so that the processing unit 171 may control the using interface of the electronic device to execute instructions or perform a browsing by means of a sensing signal generated by the touch layer 110 and a pressing signal generated by the pressing element 175.

In addition, as for the processing element 171 of the present embodiment, when a user touches any one of the virtual keying areas 111, 112, 113, 114, 115, 116, 117 and applies a press force larger than a predetermined force, the pressing element is instantly pressed to generate a pressing signal. Therefore, the processing unit 171 controls the operation of the electronic device by means of a sensing signal generated by the touch layer 110 and a pressing signal generated by the pressing element 175. However, whether the processing unit 171 may control the operation of the electronic device only upon actually receiving the sensing signal and the pressing signal is not limited in the present invention. For example, the processing unit 171 may control the operation of the electronic device by means of either a sensing signal generated by the touch layer 110 or a pressing signal generated by the pressing element 175. The one skilled in the art can perform a design according to practical using condition.

Furthermore, whether the touch input device 10 controls the electronic device via wired transmission or wireless transmission is not limited in the present invention. The one skilled in the art can perform a design according to practical using condition.

[Another Embodiment of the Touch Input Device]

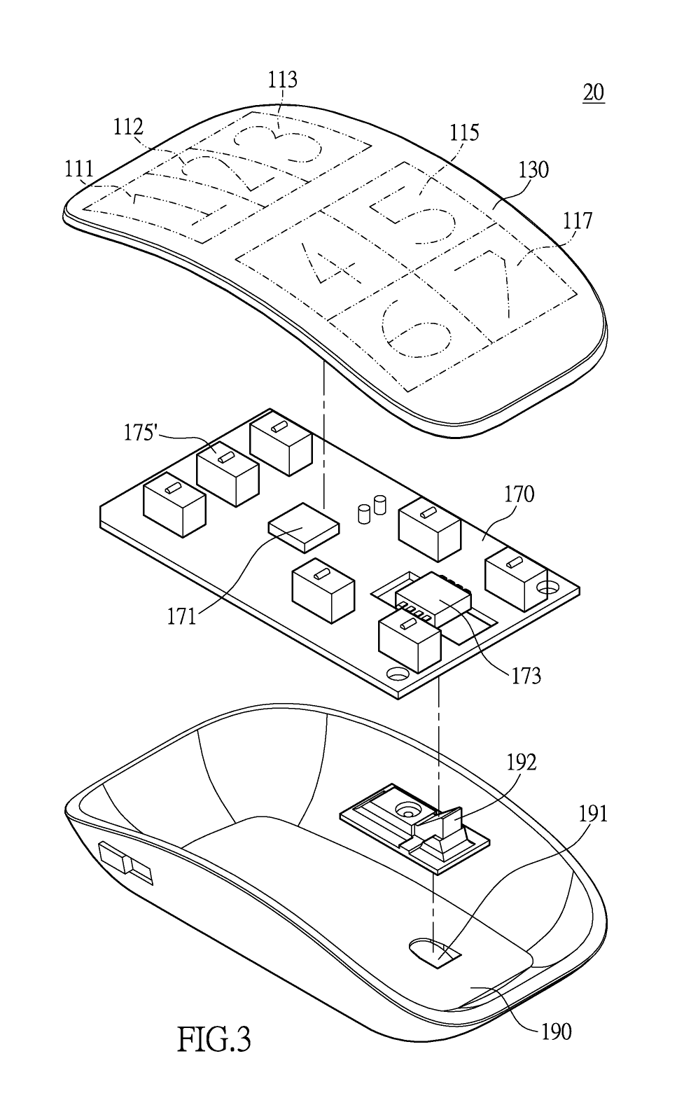

Please refer to FIG. 2 along with FIG. 3. FIG. 3 shows a decomposition diagram of a touch input device according to another embodiment of the present invention. Compared to the pressing element 175 in the circuit board 170 of FIG. 2, the circuit board 170 of FIG. 3 has several pressing elements 175′, wherein each pressing elements 175′ corresponds to one of the virtual keying areas 111, 112, 113, 114, 115, 116, 117. Therefore, when a user touches any one of the virtual keying areas 111, 112, 113, 114, 115, 116, 117 and applies a press force larger than a predetermined force, the corresponding pressing element is instantly pressed to generate a sound effect. For example, when a user touches a virtual keying area 111 and actually performs a pressing, then the pressing element 175′ correspondingly below the virtual keying area 111 is also pressed and generates a sound effect, so as to let a user determine whether the virtual keying area 111 is actually touched and actually pressed by the user. Hence, the processing unit 171 may control the using interface of the electronic device to execute instructions or perform a browsing by means of a sensing signal generated by the touch layer 110 and a pressing signal generated by the pressing element 175.

[Another Embodiment of the Touch Input Device]

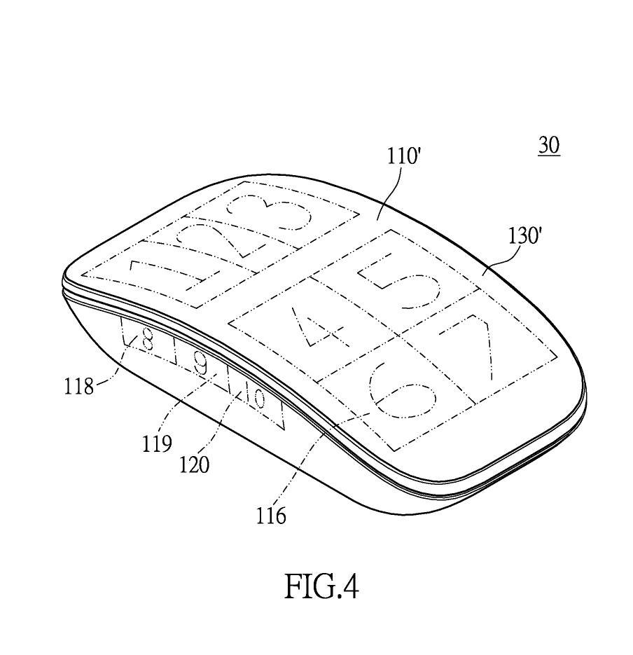

Please refer to FIG. 1, FIG. 3 and FIG. 4. FIG. 4 shows a schematic diagram of a touch input device according to another embodiment of the present invention. Compared to the touch input device 10 in FIG. 1 and the touch input device 20 in FIG. 3, except that the top surface of the touch input device 30 is provided with a touch layer 110′ and a display layer 130′, both the touch layer 110′ and the display layer 130′ of the present embodiment extend to the side wall of the touch input device 30 body (the side wall is located at the side of the body). Therefore, except that the top surface of the touch input device 30 is provided with several virtual keying areas 111, 112, 113, 114, 115, 116, 117, the side wall of the touch input device 30 can be additionally provided with several virtual keying areas 118, 119, 120. In the present embodiment, the side wall of the touch input device 30 is provided with several virtual keying areas 118, 119, 120. However, the amount of the virtual keying areas provided on the side wall is not limited in the present invention, and can be designed according to application requirement of real products. Hence, except that a user can set different functions for several virtual keying areas 1, 2, 3, 4, 5, 6, 7 provided on the top surface of the touch input device 30 according to personal preference, the virtual keys 7, 8, 9 on the side wall of the touch input device 30 can also be set, so as to execute instructions or perform a browsing for the using interface of an electronic device.

[Possible Efficacy of Embodiments]

Summing up the above, virtual keys of different functions can be set for the touch input device provided by the embodiment of the present invention according to a user's preference. When a user touches and presses any virtual key, the pressing element is instantly pressed to generate a sound effect, so that the user can actually know whether the touched virtual key is successfully touched and pressed, so as to let a user still keeps the legibility and convenience of a conventional input device when the user uses the touch input device.

In addition, the embodiments of the present invention provide some touch input devices, several virtual keys of which can be disposed not only on the top surface of the touch input device body but also on the side wall thereof. Therefore, a touch input device of high freedom is provided for both the electronic game players and the users who frequently use text processing. Hence, the touch input device can be used more flexibly, and the requirements of different users can be further satisfied.

Moreover, the embodiments of the present invention provide some touch input devices, the display layer of which can display several keys and keying functions thereof. Hence, it is not necessary to remember all the keying functions, so a user can feel more convenient when the touch input device is used.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A touch input device, suitable for controlling an electronic device, comprising:
a body, having a containing portion;
a display layer, disposed on the body and used for displaying at least one virtual key;
a touch layer, disposed on the display layer and used for sensing whether the virtual key is touched by a user, thus generating a sensing signal;
a processing unit, disposed in the containing portion and electrically connected to the touch layer and the display layer; and
a pressing element, disposed below the touch layer and electrically connected to the processing unit, wherein when the user touches any virtual key with a press force larger than a predetermined force, the pressing element is instantly pressed to generate a pressing signal;
wherein the processing unit is used for controlling the operations of the electronic device by means of a sensing signal generated by the touch layer and a pressing signal generated by the pressing element.

2. The touch input device according to claim 1, wherein a bottom shell of the body comprises a mobile sensing module, which is used for sensing a reflective light signal on a plane disposed for the touch input device.

3. The touch input device according to claim 1, wherein both the touch layer and the display layer extend to a side wall of the body.

4. The touch input device according to claim 1, wherein the display layer and the touch layer are of arc-curved surface shape.

5. The touch input device according to claim 1, wherein the virtual key is a functional key or a numerical key.

6. The touch input device according to claim 1, wherein the display layer displays several virtual keys, and when a user touches any said virtual key, the pressing element is instantly pressed.

7. The touch input device according to claim 1, wherein the display layer displays several virtual keys, and wherein each said pressing element corresponding to each said virtual key, when a user touches any said virtual key, the corresponding pressing element is instantly pressed.

8. The touch input device according to claim 1, wherein the touch input device controls the electronic device via a wired transmission or a wireless transmission.

9. The touch input device according to claim 1, wherein the touch input device is a mouse.

10. The touch input device according to claim 1, wherein the pressing element generates a sound effect when the pressing element is pressed.
